(19) United States
(12) Patent Application Publication
(10) Pub. No.: US 2007/0268250 A1
(43) Pub. Date: Nov. 22, 2007

(54) Remote input device for computers

(75) Inventor: Byung Kon Min, Palo Alto, CA (US)

Correspondence Address: Byung Kon Min, 890 Los Robles Ave, Palo Alto, CA, 94306, US

(73) Assignee: Nubron Inc., Palo Alto, CA (US)

(21) Appl. No.: 11/711,385

(22) Filed: Feb. 27, 2007

Related U.S. Application Data
(60) Provisional application No. 60/777,069, filed on Feb. 27, 2006.

(51) Int. Cl. G06F 3/033

(52) U.S. Cl. 345/158

(57) ABSTRACT

A palm sized input device for computers comprises a first cursor position sensor which is mounted on the underside and may be operated by a finger, typically the index finger or the middle finger, from the underside of the device (hand held mode); a second cursor position sensor which may be operated by sliding said device along a flat surface with one hand like a conventional mouse (mouse mode); a mode switching means to change the mode between the hand held mode and the mouse mode; at least one means, usually the left click mouse button, to accept the current cursor position; and an alphanumeric keyboard mounted on the top surface. In the preferred embodiment, the top mounted alphanumeric keyboard fully integrates most key functions of a standard QWERTY keyboard by placing the alphanumeric and symbol keys in plurality of circular layers substantially following the geometry of the clock face, i.e., 30 degrees apart angularly.

### CROSS-REFERENCE TO RELATED APPLICATIONS

This application claims the benefit of the provisional application “Remote Input Device,” Ser. No. 60/777,069 filed on Feb. 27, 2006 by the present inventor.

### FEDERALLY SPONSORED RESEARCH

Not Applicable

### SEQUENCE LISTING OF PROGRAM

Not Applicable

### BACKGROUND OF THE INVENTION—FIELD OF THE INVENTION

The present invention relates to data entry devices for electronic instruments and more particularly to a space efficient and easy-to-use dual-mode device operated either as a handheld unit or in mouse configuration that is compatible for use in a wide variety of data entry applications.

### BACKGROUND OF THE INVENTION—PRIOR ART

The Internet and Internet Protocol TVs are fast becoming a preferred mode of entertainment delivery. More and more PCs are used for multi media entertainment. Full size QWERTY keyboards supplemented by point-and-click devices such as a mouse are usually used to perform data entry and commands for PCs. To find entertainment content from the Internet and watch them on a computer monitor from distance, a hand held, mobile device that can remotely perform the typical keyboard and mouse data entry and command functions is convenient. The objective of the present invention is to provide computer users with an alternate to the combination of QWERTY keyboard and mouse, which are typically bulky and inconvenient for mobile uses, in a novel, dual-mode, palm size platform, which is highly mobile.

The “Circular Keyboard,” U.S. Provisional Patent 60/726,932 Oct. 15, 2005 and U.S. patent application Ser. No. 11/581,303 Oct. 16, 2006, describes a circular keyboard that contains substantially full alphanumeric keyboard functions of a standard QWERTY keyboard in a small footprint.

The present invention combines a topside keyboard with an underside mouse such that full computer access is provided in a palm-sized device for single-handed use. The novelty in the invention is the combination of features into a dual-mode, palm size data entry device in an ergonomically efficient way. This device, independent of specific implementation, alternates between hand-held mode and mouse mode based upon the position of the device with respect to the hand or to the flat surface in contact that is internally sensed and switched.

Three general features: top surface data entry, bottom surface position sensing and internally contained mode sensing and switching are uniquely combined. The simplest embodiment would be a mouse that may also be hand-held to point and click in a manner that internally senses and switches between the two operational modes. The preferred embodiment includes a full keyboard, position commanding features for both modes of operation on the bottom surface, and a sensing and control system to switch between modes contained within the device.

### BACKGROUND OF THE INVENTION—OBJECTS AND ADVANTAGES

It is the objective of the present invention to combine substantially full keyboard functions and mouse functions in a hand held unit,

It is the advantage of the present invention to place the cursor position sensor underside so that in the hand held mode, the fingers on the underside may easily navigate the cursor while thumbs on the top are used for typing and operating other functional keys,

It is the advantage of the present invention to place a circular keyboard on the top for space efficiency, typing efficiency, and for substantially full keyboard functions,

It is the advantage of the present invention to allow switching from the hand held mode to the mouse mode which may be used to reduce the fatigue of fingers and hands if a flat surface such as coffee table is nearby,

It is the advantage of the present invention that it is a space efficient and easy-to-use dual-mode device operated either as a handheld unit or in mouse configuration that is compatible for use in a wide variety of data entry applications,

It is the advantage of the present invention that a single handed data entry with substantially full keyboard functions is enabled,

It is the advantage of the present invention to combine any of a variety of keyboards with any of a variety of position sensors to realize a wireless keyboard/mouse device that is novel by its use of dual-mode sensing and switching.

### SUMMARY OF THE INVENTION

A hand-held computing and communications device combines a keyboard on the topside with position sensors on the underside, and a mode sensor and switch inside to enable single-handed computer access, either similar to a mouse when moved across a flat surface to determine screen cursor location or as a self-contained hand-held data entry unit. Any of a variety of keyboards is combined with any of a variety of position sensors to realize a wireless keyboard/mouse device that is novel by its use of dual-mode sensing and switching.

### BRIEF DESCRIPTION OF THE DRAWINGS

FIG. 1 depicts the operation of the device in the hand held mode. The user can use his/her index finger or middle finger to operate the track ball on the underside, while using the thumb to click the left or right click button on the top and to operate a keyboard on the top.

FIG. 1a depicts the operation of the device in the mouse mode. The unit may be moved upon a flat surface with a hand and wrist, positioning the cursor or “pointing” as with a conventional mouse while fingers accessing the keyboard and click buttons on the top.

FIG. 2 shows the side view and the top view of the preferred embodiment of the present invention.

FIG. 3 shows the side view and the underside view of the preferred embodiment of the present invention.

FIGS. 4 and 5 show an embodiment of the circular keyboard with a preferred English and Korean alphanumeric key arrangement, respectively.

### DETAILED DESCRIPTION OF THE INVENTION—PREFERRED EMBODIMENT

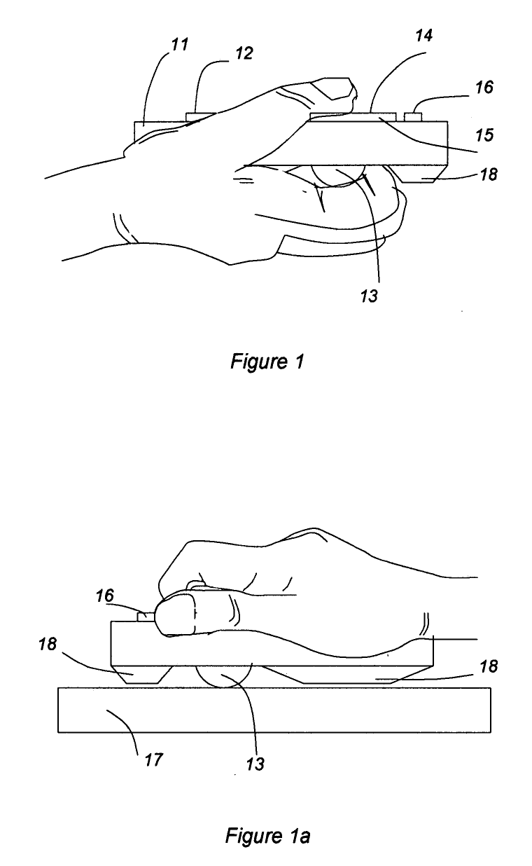

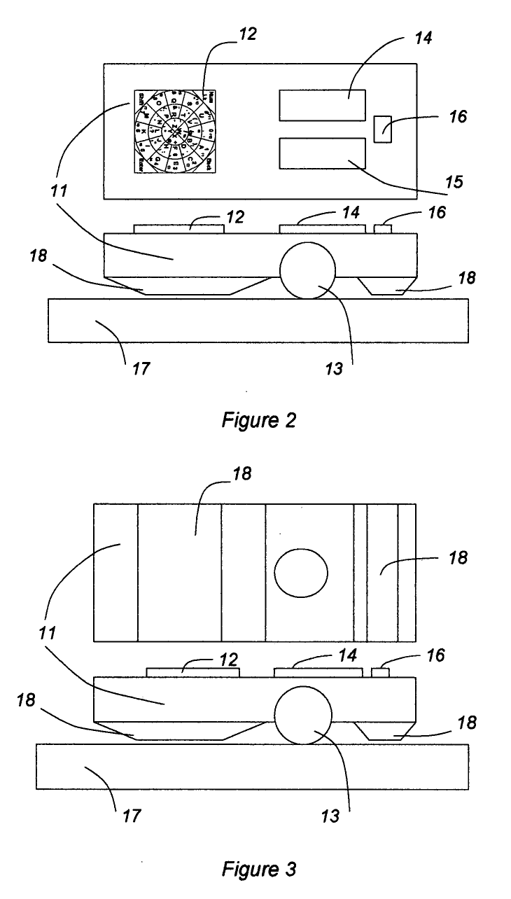

Referring to FIGS. 1 through 3, on the top surface of the body 11 protruding are a alphanumeric keyboard 12, left click and right click buttons 14 and 15, respectively, and the mode switch 16.

The track ball 13 protrudes from the body 11 to underside. As shown in FIG. 1, a user may hold the body 11 with her right hand, her right thumb on top of the body and the right index finger on the underside of the body. The fingers on the underside can naturally touch the protruding track ball 13 and rotate it in the direction she desires the cursor on the computer screen to move. The thumb on the top surface can rest on top of the click button 14 or 15 and click to operate the mouse function. The user can easily move her thumb on top of the keyboard 12 and push a desired key to type or input data or to operate the computer. Alternatively, a user may hold the device in her left hand, operate the underside trackball with the fingers of the same hand, and operate the keyboard and other functional keys on the top with the right hand and its fingers.

The underside is shaped so that the fingers find room to operate the track ball. 18 is an extension of the body 11 providing flat surface such that when the user place the device on a flat surface such as coffee table or on a mouse pad 17, the track ball may be slightly pressed by the weight of the device and upon sliding the device along the surface, the device functions as a regular mouse. The user must use the switch 16 to change the mode between the hand held mode and the mouse mode. In the hand held mode, the cursor moves in the same direction as the finger controlling the trackball. In the mouse mode, the cursor moves in the same direction as the hand moving the device on a flat surface.

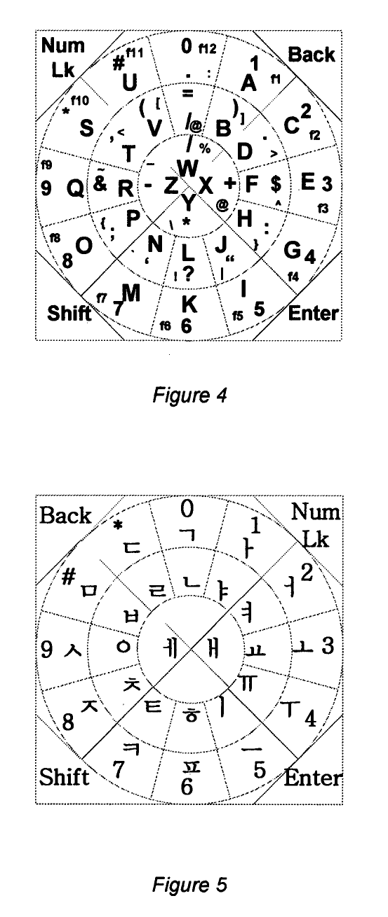

The keyboard 12 is substantially a full keyboard comparable to standard QWERTY keyboards. FIGS. 4 & 5 show placement of alpha-numeric characters and command keys such as number lock, back, shift, and enter on a circular keyboard. The permutation of the 28 keys by number lock and shift keys provides a total of 112 alphanumeric characters. In addition to the 10 numerals, 26 alphabets, and * and # keys, 76 additional symbols can be made available on this hand held device.

The position sensor depicted is a track-ball electromechanical design that is representative of any variety of position sensor located on the underside of the keyboard to establish the novelty of the invention.

What is claimed are:

1. A palm sized input device for computers, comprising:
A first cursor position sensor mounted on the underside and may be operated by a finger, typically the index finger or the middle finger, from the underside of the device (hand held mode),
A second cursor position sensor that may be operated by sliding said device along a flat surface with one hand like a conventional mouse (mouse mode),
at least one mode switching means, to change the mode from the hand held mode to the mouse mode or vice versa, such that in said hand held mode, the cursor moves in the direction of finger movement and in said mouse mode the cursor moves in the direction of hand movement,
at least one means, usually the left click mouse button, to accept the current cursor position,
a first electromagnetic signal generator to operate said first cursor position sensor in accordance with said operation of said first sensor;
a second electromagnetic signal generator to operate said second cursor position sensor in accordance with said operation of said second senor;
a third electromagnetic signal generator to operate said mode switching means in accordance with said operation of said switching means,
a fourth electromagnetic signal generator to operate said click button in accordance with said operation of said click button;

2. A palm sized remote input device for computers of claims 1, wherein
Said mode switching means further comprising:
a fifth signal generator to automatically detect and set the hand held mode when the device is used in the hand held mode and set the mouse mode when the device is used in the mouse mode,

3. A palm sized remote input device for computers of claim 1, wherein
Said first cursor position sensor is of a trackball type,

4. A palm sized remote input device for computers of claim 1, wherein
Said first cursor position sensor is of a touchpad type,

5. A palm sized remote input device for computers of claim 1, wherein
Said first cursor position sensor and said second cursor position sensor are the same, of the trackball type, but operated in dual modes: (1) by a finger, typically the index finger or the middle finger, from the underside of the device (hand held mode) and (2) by one hand sliding said device along a flat surface like a conventional mouse (mouse mode),

6. A palm sized remote input device for computers of claim 1, further comprising an alphanumeric keyboard mounted on the top surface
